(19) United States
(12) Patent Application Publication
(10) Pub. No.: US 2016/0335351 A1
(43) Pub. Date: Nov. 17, 2016

(54) SYSTEM AND METHOD FOR PROVIDING A SEARCH ENGINE, AND A GRAPHICAL USER INTERFACE THEREFOR

(71) Applicant: Barletta Media Ltd, Cheltenham (GB)

(72) Inventors: Maksims Volkovs, Cheltenham (GB); William Hemming, Cheltenham (GB); Francesco Petruzzelli, Cheltenham (GB); Andrew Curran, Cheltenham (GB)

(21) Appl. No.: 15/154,422

(22) Filed: May 13, 2016

(30) Foreign Application Priority Data
May 14, 2015 (GB) GB1508269.6

(51) Int. Cl. G06F 17/30; G06F 3/0486; G06F 17/24; G06F 3/0484

(52) U.S. Cl. CPC G06F 17/30864; G06F 17/30554; G06F 17/30115; G06F 3/04847; G06F 3/04842; G06F 3/0486; G06F 17/24; G06F 17/30312

(57) ABSTRACT

A computer-implemented search system comprising a search engine and a database, the search engine being configured to perform an Internet search in response to a search query and display results of a search on a screen of a user's computing device, the system being configured to:
provide and display a selectable function configured such that, when selected by a user, a new folder is created; enable a user to select one or more search results displayed on their screen and cause it/them to be moved into said new folder; and save the new folder including the one or more search results in the database;
wherein the search engine performs a search of the database, in response to a search query, and displays data representative of relevant folders including search results created by other users and stored in the database together with the search results.

### RELATED APPLICATIONS

This application claims priority to UK Patent Application GB1508269.6, filed May 14, 2015. The entire teachings of the above application are incorporated herein by reference.

### BACKGROUND OF THE INVENTION

1. Field of the Invention

The present invention relates generally to a computer-implemented search system and method for providing a search system and, more particularly, to a search system having an application programming interface communicably coupled with a search engine for obtaining, organizing and displaying search results, and a graphical user interface (GUI) therefor.

2. Description of the Related Art

Search engines are well known in the art for performing searches on the Internet, and comprise computer programs that, when a search query is entered, retrieve relevant information and/or pointers to the location of relevant information, typically by performing a matching process between key words used in the search query and tags associated with information stored in its search database.

Conventional search engines tend to return search results, ranked in accordance with a relevance value, usually derived from a relevance algorithm that is configured to assess the accuracy of the match between the query and the returned content. The search results are thus displayed in order of their rank via a GUI, in the form of respective hyperlinks which, when opened, re-direct the user to the website containing the respective information.

Conventional search engine GUIs are intentionally kept as simple as possible, in order to ensure that they are user-friendly, so as to maximise the base of potential users and thereby increase usage. However, on the other hand, it is desirable to provide a search engine and GUI therefor which enables a user to organise and display search results according to their specific requirements. Typically, bookmarks have been used to enable a user to organise their search results. However, more recently, the use of tags has been proposed for organising a series of hyperlinks under a tag name defined by the user, which is considered to be beneficial because tags can be shared with other users.

Accordingly, United States Patent Application Publication no. 2007/0276811 A1 describes a graphical user interface for displaying and organizing search results, in which the search result section is provided with a number of subsections, and each subsection may contain one or more search results. The search result(s) in any one of the subsections can then be updated upon receipt of new data, independently of the other subsections. The described GUI provides a further functionality whereby search results form any of the subsections can be picked up, dragged and dropped into a general area to create a tailored search listing collection that can be shared with other users and may even appear in one of the above-mentioned subsections as a search result.

The search listing collection thus created within the general area of the GUI can be shared with other users by, for example, email, at the instigation of the creator. However, unless the search listing collection thus created is actually sent in this manner to another user, other users cannot benefit from the creator's efforts. Furthermore, it would be desirable to provide a ranking system for search results that is more accurate, dynamic and intuitive than simply keyword matching.

### SUMMARY OF THE INVENTION

In accordance with an aspect of the present invention, there is provided a computer-implemented search application comprising a graphical user interface, an application programming interface communicably coupled to a search engine, and a database, said search engine being configured to perform an Internet search in response to a search query and display results of said search on a screen of a user's computing device, said application programming interface being configured to:
provide a selectable function and display a control element representative thereof, via said graphical user interface on said screen of said user's computing device, said selectable function being configured such that, when selected by a user, a new folder is created;
enable a user to select one or more search results displayed on said screen and cause it/them to be moved into said new folder;
display, via said graphical user interface, data representative of said new folder including said one or more search results contained therein; and
save said new folder including said one or more search results in said database;
   said application programming interface being further configured to cause said search engine to perform a search of said database, in response to a search query, and display on said screen data representative of relevant folders including search results created by other users and stored in said database together with said search results.

The application programming interface may be configured to enable a user to apply a chosen name to said folder, said name being in the form of an alphanumeric string entered by said user.

The application programming interface may be configured to enable a user to select one or more search results displayed on said screen in respect of a further Internet search, and cause it/them to be moved to a folder previously created by said user.

The application programming interface may be configured to enable a user to edit search results within a folder by deletion, amendment and/or reordering.

The application programming interface may be configured to enable a user to attach a privacy tag to a folder, said privacy tag being configured to prevent a folder to which it is attached from being accessed by other users.

The application programming interface may be configured to enable a user to attach one or more relevancy tags to a folder.

The application programming interface may be configured to protect folders such that only the user that created a folder can perform the one or more of the following actions in respect thereof: deletion of entries, adding of entries, reordering of contents, adding relevancy tags. In addition, the creator of a folder may choose to authorise another user, or multiple users, to collaborate on the folder, giving them access to make certain adjustments/alterations to the folder, including, but not limited to, adding and/or removal of content, reordering and/or adding and/or changing relevancy tags.

The application programming interface may be configured to apply a score to a folder containing search results, said score being indicative of the potential relevance and/or quality of said search results. In this case, the score may be based on the identity of a user that created the respective folder. The score may, additionally or alternatively, be based on said search results, and is calculated using one or more of many variables reflecting user interaction with content both within that collection and within other search results. Statistics such as bounce rates of links to said search results and/or time spent scrolling through said search results by other users can be used to rank these results, as well as other functions. The score may, alternatively or additionally, be based on relevance to search query, wherein said score is calculated using keyword relevance criteria.

The application programming interface may be configured to enable a first user to invite other users to contribute search results to a folder created by said first user. In this case, the application programming interface may be configured to enable a user to send an electronic invitation to another user which, once accepted, causes said application programming interface to apply editing permissions to an invited user in respect of a specified folder. Such editing permissions may be limited to the addition of search results to said specified folder.

### BRIEF DESCRIPTION OF THE DRAWINGS

So that the manner in which the above recited features for the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A and 1B are schematic illustrations demonstrating the manner in which standard search results are generated (FIG. 1A) and displayed (FIG. 1B);

FIGS. 2A and 2B are schematic illustrations demonstrating the manner in which a new collection can be created (FIG. 2A) and displayed (FIG. 2B), using an application programming interface according to an exemplary embodiment of the present invention;

FIGS. 3A and 3B are schematic illustrations demonstrating the manner in which search results can be added to a collection in an application programming interface according to an exemplary embodiment of the present invention;

FIGS. 4A and 4B are schematic illustrations demonstrating the manner in which search results can be updated using collections using an application programming interface according to an exemplary embodiment of the present invention;

FIGS. 5A and 5B are schematic illustrations demonstrating the manner in which collection orders can be organised by a user;

FIGS. 6A and 6B are schematic illustrations demonstrating the manner in which requests for collections can be effected via an application programming interface according to an exemplary embodiment of the present invention;

FIG. 7 is a schematic flow diagram illustrating some of the principal steps involved in a method of using collections within an application programming interface according to an exemplary embodiment of the present invention; and

FIG. 8 is a schematic flow diagram illustrating some of the principal steps involved in a method of searching via an application programming interface according to an exemplary embodiment of the present invention.

### DETAILED DESCRIPTION

Thus, one aspect of the present invention enables a user to store selected search results in fully customisable and named folders (hereinafter referred to as “collections”) which any authorised user can create without limits.

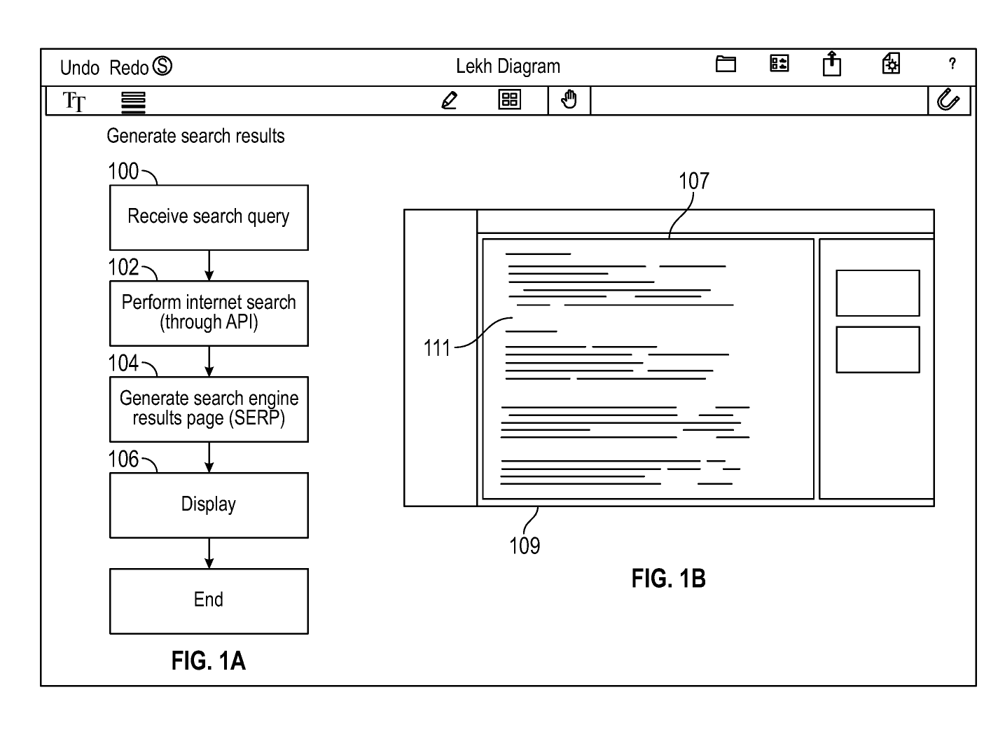

FIGS. 1A and 1B illustrate schematically the generation of conventional search results using a typical application programming interface (API) such as that provided by many large search engines, such as Bing or Yandex. Thus, at step 100, the API receives a search query, usually in the form of a set of key words entered by a user into a text box provided by the GUI.

An internet search is performed through the API, at step 102, and a search engine results page (SERP) is generated at step 104. The search results thus obtained can be considered as a “collection” which is displayed at step 106 as a search results page 107 on the user's screen 109, typically as a brief description, an image, video, article or quote combined with hyperlinks 111 which a user can open to be directed to the respective website.

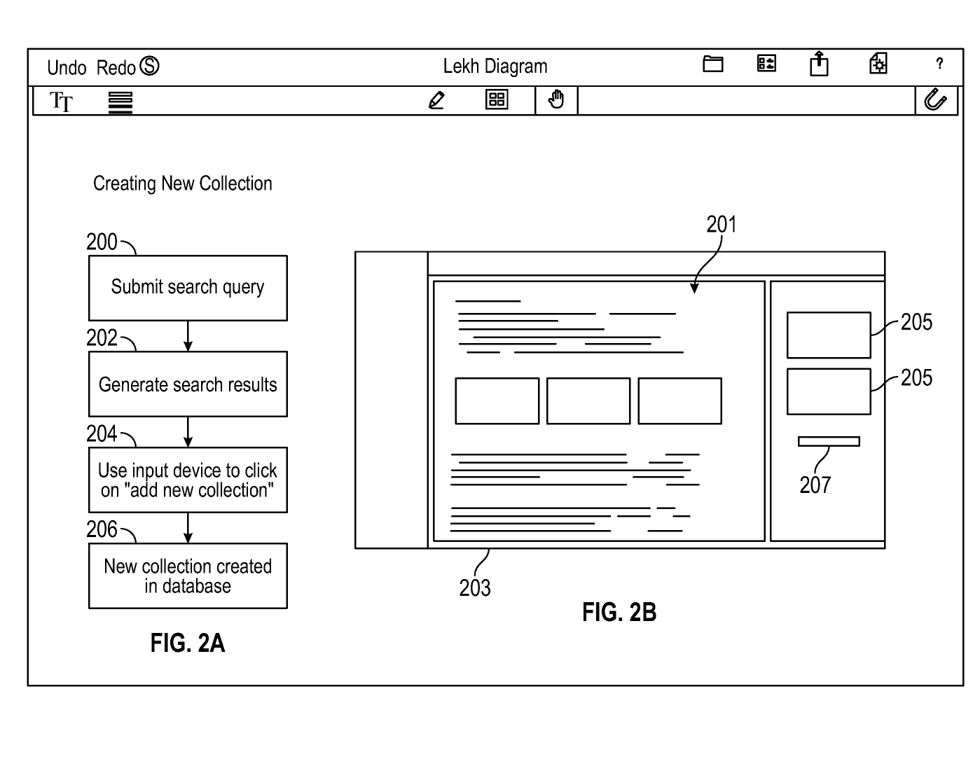

Before adding search results to a collection, the user must first create a new collections folder. Referring to FIGS. 2A and 2B of the drawings, a user first submits a search query, at step 200, and then search results 201 are generated as before, at step 202. As shown in FIG. 2B, existing collections 205 may be displayed on the user's screen 203, and the GUI provides a click button 207 denoted “add new collection”, or similar. Thus, at step 204, the user can use their input device to click on the button 207 to create, at step 206, a new folder for a new collection, and a visual representation thereof, in the form of a selectable box, will appear in the right hand side of the user's screen 203 along with any other, previously-created collections 205. The user may be given the option to name the folder, and the new collections folder is automatically saved to a database.

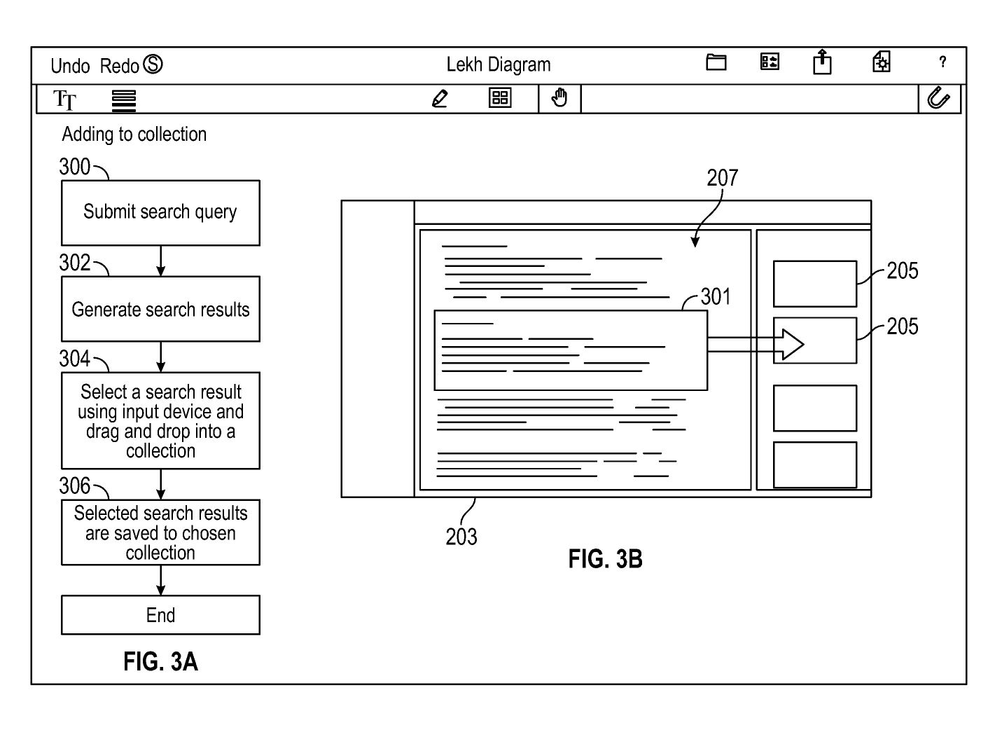

A user can now add search results to a selected one or more of any of the collection folders 205. Referring to FIGS. 3A and 3B of the drawings, once again, the user submits a search query at step 300, and search results 201 are generated at step 302 and displayed on the user's screen 203. At step 304, the user may select one of the search results 301, using their input device, and drag and drop it into a selected one of the collections folders 205, where it is automatically saved, at step 306, on the database. Results can also be added to collections by way of a bookmarking option within the browser extension of the GUI application bar. Thus, whilst a user is actually on a website, they can, if they wish, add the page or website they are looking at to a selected collection by simply clicking the bookmark option and then selecting the destination collection folder from a drop down selection menu, similar in many respects to the manner, functionally, in which a user can share a page or website with other users by sharing it in conventional applications. If a user clicks on any of the collection boxes 205 it will be expanded and replaces the original search results page on the user's screen 203, in other words, the list of saved results within the collection replaces the original search results list on the screen. The results on the page thus displayed can be clicked and dragged in order to enable the user to reorganise the list of saved results into an order that suits them. Additionally, each saved result may have associated therewith a “delete” button, to enable a user to delete any results they wish to from that collection.

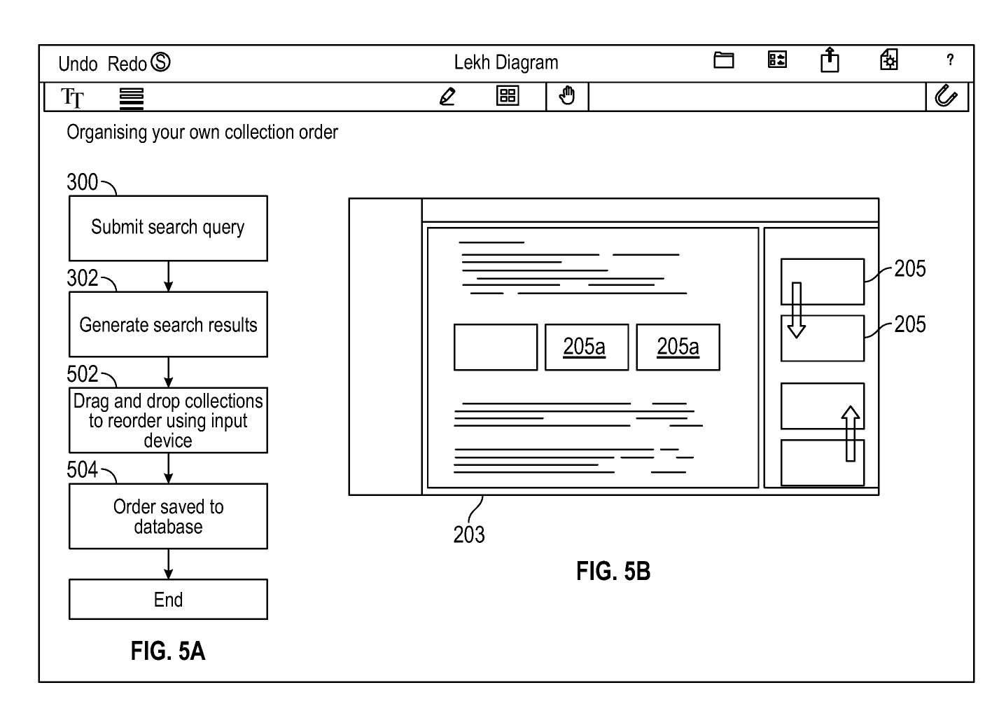

It can be seen from FIGS. 5A and 5B, that the proposed system also allows a user to organise and reorganise their own collections 205 (which are displayed on the right hand side of the screen 203 in the described exemplary embodiment) simply by dragging and dropping them (step 502) into the required order (from top to bottom or side to side relative to the screen to create a tiled page), using their input device. The selected order of content within collections 205 is then saved, at step 504, to the database such that the collections 205 are always displayed to that user in the last selected order.

Each collection has a number of associated input fields, displayed to the user via the GUI. These input fields allow the user to change the name of the collection (i.e. the title of the folder), add a number of (e.g. three) relevancy tags, as will be described later, delete the folder, make it “private” (i.e. not visible or otherwise accessible to other users), or share it via social media, email or a unique collections link, for example.

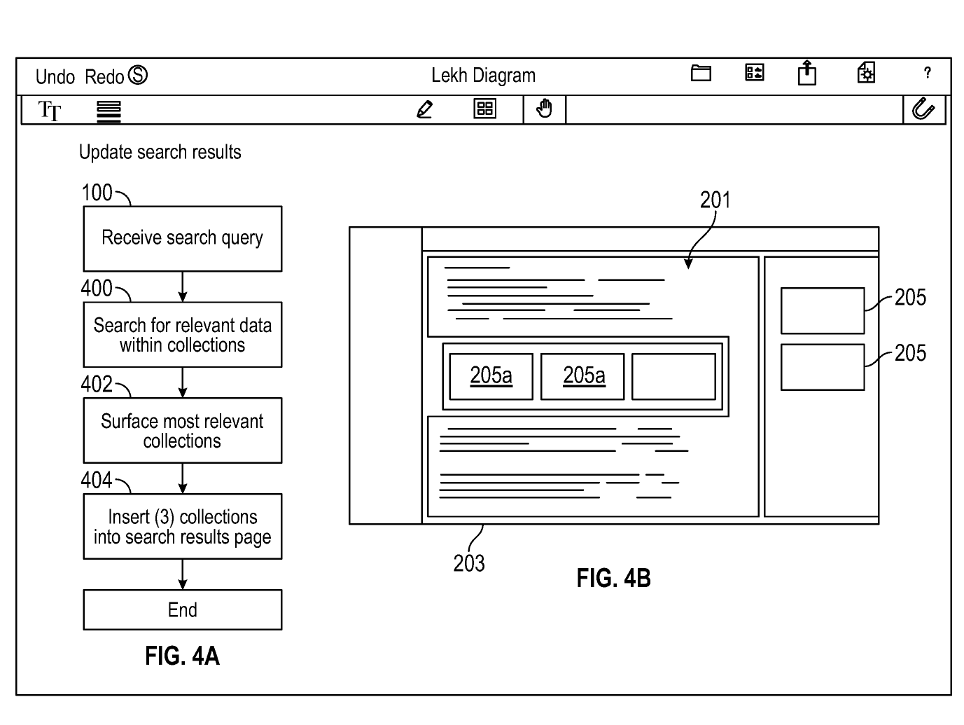

Thus, all collections not marked private, are available to be accessed by other users of the search engine. Referring to FIGS. 4A and 4B of the drawings, when the search engine receives a search query, at step 100, it will not only perform an internet search, but it will also search the database for relevant data within all non-private user collections (at step 400), retrieve, at step 402, the most relevant collections, and insert, say, three of the most relevant collections 205 a into the search engine results page at step 404. The position or ranking of the collection ‘tiles’ 205a within the conventional search results 201 is determined by the relevancy rating associated therewith, as will be described later. Thus, those considered to be popular alternatives to the conventional search results will appear close to the top of the list of results and promoted as alternatives to the standard results, whereas collections determined to be only potential alternatives may be positioned further down the page displayed on the screen 203.

The collections search referred to above takes into account a number of factors in order to rate both the relevance and quality of the collections to output. Thus, and in order to ensure that high quality user collections are retrieved, where appropriate, for each query, each collection is scored based on four principal factors:
Importance of the collection creator—this will be based on the number of collections they have created, their login method (e.g. Facebook or standard), rating of previous collections, etc.
Collection Quality—this is based on the content of the collection, which is scored using various factors including, but not limited to, bounce rates of links and time spent scrolling through the collection, as well as user feedback using a manual rating function.
Relevance to the query—this enables the key word search functionality to be incorporated within the collection search, as well as the above-mentioned rating system.
User actions—for example, when a user ‘bounces’ from a link (i.e. opens it and very quickly closes it again), that link would be down-scored. Any links on which users generally stay for longer may conversely be up-scored.

In more detail, therefore, the following two scores may, in some exemplary embodiments, be used for collection retrieval and scoring:
relevance to the query
collection quality

In the following sections preliminary scoring formulas are exemplified for both scores.

### Relevance to the Query

Relevance score typically has two components—static and dynamic. Static score is user-session independent and measures the absolute relevance to the query. Dynamic score takes into account user actions and adjusts the static score accordingly. For example, if user skipped or bounced (see below) from a Wikipedia page then the relevance score of all collections that contain this wiki page should be reduced.

In the absence of user search data, static scores can be derived using the search engine ranking. Given a query q, search engine returns an ordered list of n documents (web pages) D_{q}={d_{q1}, . . . d_{qn}} where d_{q1} is ranked first, d_{q2} is ranked second and so on. For any collection c with m documents D_{c}={d_{c1}, . . . , d_{cm}}, the aim is to estimate the static relevance score between q and c.

The main idea for deriving this score is to consider the overlap between documents returned by the search engine and those in c. Large search engines spend considerable amount of effort optimizing query-document relevance. We can leverage this strength and use results retrieved by the search engine to guide our collection retrieval procedure. Intuitively the goal is to surface collections that have a large degree of overlap with documents that are ranked high in search engine's results.

Formally, this can be computed by considering the overlap between document sets for q and c:

S(q,c)=f(D_{q},D_{c}) (1)

A number of alternatives are possible for f, the first alternative being a variation of the commonly used Jaccard similarity (http://en.wikipedia.org/wiki/Jaccard_index):

$$f ( {D}_{q} , {D}_{c} ) = \frac{\vert {D}_{q} ⋂ {D}_{c} \vert}{\vert {D}_{c} \vert} \qquad ( 2 )$$

where D_{q}∩D_{c} is the intersection of D_{q} and D_{c} computed using document URLs as unique IDs;
0≦f(D_{q},D_{c})≦1 computes the fraction of the document in D_{c} that also appear in D_{q} and approaches 1 when most documents in D_{c} overlap with D_{q}. This formulation has two potential drawbacks: first, intersection in Jaccard similarity is done over unordered sets and thus ignores document rankings; and second, normalizing by |D_{c}| penalizes collections that have many documents which could be undesirable since larger collections can be more comprehensive and of higher quality.

In order to account for these drawbacks, it is possible to incorporate document rank information into the score calculation:

$$f ( {D}_{c} , {D}_{q} ) = {\sum }_{{d}_{gi} ∈ {D}_{q} • {D}_{c}} g ( i ) \qquad ( 3 )$$

where g(i) is a monotonically decreasing function of I, for example

$$g ( i ) = \frac{1}{i} .$$

In this formulation, the sum is still over documents d_{qi} that appear in the intersection D_{q}∩D_{c} but now rank position i of d_{qi} in D_{q} is used to calculate the score through g(i). The contribution from each document is thus proportional to its rank position and higher ranked documents contribute significantly more than lower ranked ones. Note that for the collection with m documents, the maximum score is Σᵢ₌₁^{m}g(i) achieved when all m documents in D_{c} also appear in positions 1 to m in D_{q}. Since maximum score is not bounded and increases with m, larger collections with more documents can have greater scores than smaller collections. This formulation thus addresses both drawbacks discussed above. Moreover, if normalization is desired, the score can be readily re-factored to lie in [0,1]:

$$f ( {D}_{q} , {D}_{c} ) = \frac{{\sum }_{{d}_{gi} ∈ {D}_{q} ⋂ {D}_{c}} g ( i )}{{\sum }_{j = 1}^{m} g ( j )}$$

To illustrate how Equation (3) is computed, consider the following example with D_{q}={x, y, z, w), D_{c}={w, y, u} and

$$g ( i ) = \frac{1}{i} .$$

The intersection of D_{q} and D_{c} is {y, w}, y has rank 2 in D_{q} and w has rank 4 so the static score is:

$$S ( q , c ) = g ( 2 ) + g ( 4 ) = \frac{1}{2} + \frac{1}{4} = 0.75$$

Note that for the collection with m documents the maximum static score is

$${\sum }_{i = 1}^{m} \frac{1}{i}$$

if all m documents in c also appear in positions 1 to m in D_{q}. Similarly, the minimum value is 0 if D_{c} and D_{q} don't intersect.

After computing S (q,c) for all shortlisted collections we can simply sort and present the user with top-K results. The algorithm to calculate the static score is outlined in Algorithm 1 (below).

Algorithm 1 Static Score

```
Input: query: q documents: D_{q}, collections: C = {c₁, c_{2,}....}
for cₖ in C do
    initialize S(q, cₖ) = 0
    for d_{qi} in D_{q} do
        if d_{qi} ∈ D_{ck} then
    S(q, cₖ) = S(q, cₖ) + g(i)
    end if
end for
Return: static scores {S(q, c₁), S(q, c₂), ....}
```

A number of further extensions/generalizations are possible here, the first extension is to also take into account the ranking of overlapping documents in collection:

$$S ( q , c ) = α {\sum }_{{d}_{gi} ∈ {D}_{q} ⋂ {D}_{c}} g ( i ) + β {\sum }_{{d}_{cj} ∈ {D}_{q} ⋂ {D}_{c}} g ( j ) \qquad ( 4 )$$

Here, the second sum takes into account how overlapping documents d_{cj} are ranked in c. Collections where overlapping documents are ranked near the top will get higher scores in this extension. ∝ and β are constants that control the weight of each sum and need to be set by hand. Note that most rank-based distances can be used here. For example, Spearman's ρ² and Kendall's r³ distances can be readily adapted to estimate similarity score between D_{q} and D_{c}.

A second extension is to use document domain instead of exact URL to compute intersections. For example, given a URL en.wikipedia.org/wiki/Machine_learning we can use the entire URL or just the domain part en.wikipedia.org/wiki to calculate the intersection. Given that URLs tend to change over time, whereas domains remain fixed, matching based on domain should be more robust and provide broader coverage. This, however, comes at the expense of potential false positives where scores of some collections could be artificially boosted even when documents are not particularly relevant to the query. One way to solve this problem is to combine domain matching with keyword searches to ensure that documents from the same domain are actually relevant to the query.

Keyword matching can also be combined with Equations (3) and (4) to get broader coverage. One significant drawback of using keyword matching is that it is hard to make it robust given the numerous misspellings, abbreviations and synonyms that most keywords have. As we discussed above, large-scale search engines spend considerable effort fine-tuning query-document relevance and it would be difficult to replicate this accuracy with limited resources and time. Using document intersections with corresponding rank information avoids these disadvantages and, with enough tuning, should yield comparable results.

Besides simplicity, another advantage of using URL/domain intersections is that the dynamic component can be readily incorporated into the scoring process. Consider the same example with D_{q}={x, y, z, w} and D_{c}={w, y, u,}, once user starts going through D_{q} we need to dynamically refine the score of c taking into account all user actions. It is widely accepted that users scan search results from top to bottom, stopping when desired information is found. Under this assumption we can identify that a given document was deemed not relevant by the user in the following two ways:
skip: user skips document clicking on at least one document below it. For example, y is skipped but z is clicked.
bounce: user clicks on the document but quickly comes back (“bounces”) and clicks on at least one document below it. For example, y is clicked but after only 30 seconds z is clicked.

Using these two rules we can track user session and quickly identify irrelevant documents. Once identified, these documents are then removed from the intersections and the scores are recalculated. To illustrate this, in the example above we had S (q, c)=0.75, now suppose that user either skips or bounces from y. Since rank of y in D_{q} is 2, the adjusted score becomes S(q, c)=0.75−g(2)=0.75−½=0.25. In this case, incorporating user feedback significantly reduced the collection relevance score because one of the top ranked intersection documents was found to be not relevant by the user. Note that analogous calculation can be applied to equation (4) by also subtracting rank of y in D_{c}. The algorithm to dynamically adapt the static score is outlined in Algorithm 2 below:

Algorithm 2 Dynamic Score

```
Input: query: q documents: D_{q}, collections: C = {c₁, c_{2,}....},
static scores: S = {S(q,c₁), S(q,c₂),...}
for d_{qi} in D_{q} do
    if user skipped/bounced from d_{qi} then
        for cₖ in C do
            if d_{qi} ∈ D_{ck} then
                S(q, cₖ) = S(q, cₖ) − g(i)
            end if
        end for
    end if
end for
    Return: updated score {S(q, c₁), S(q, c₂), ....}
```

One major advantage of this procedure is that it is fairly straightforward to implement. After query is issued, a subset of collections can be retrieved using static scores, and cached together with corresponding intersection sets. Then once user starts to interact with search results, each skip/bounce can be quickly removed from the intersection sets that contain its triggering score recalculation.

Several extensions are also possible here. For instance, in addition to incorporating negative feedback, we can also incorporate positive feedback. Relevant documents are typically identified by long dwell times (time spent on a page). As a result, collections that overlap with documents that user found relevant would get a score boost.

So far we have exclusively concentrated on query-collection relevance, however using this metric alone can lead to unsatisfactory user experience. At scale, many collections will be created including many similar ones. Sorting by relevance alone can produce top-K results where collections are very similar to one another and as not informative to the user. Thus, in addition to query relevance it is also important to consider collection diversity. To incorporate diversity we first need a reliable way to estimate the similarity between any two collections c₁ and c₂. Following the same ideas as before we can compute the similarity between c₁ and c₂ by intersecting the corresponding document sets (using either URL or domain info):

S(c₁,c₂)=f(D_{c}_{₁},D_{c}_{₂}) (5)

Any of the definitions for f (see equations (2), (3) and (4)) described above can also be used here.

Using collection similarity our goal in this exemplary embodiment of the present invention is then to optimize for both relevance and diversity where, ideally, top-K collections are both relevant to the query and different from one another. A number of methods have been proposed for this task (see, for example, R. Agrawal, S. Gollapudi, A. Halverson, and S. Ieong, Diversifying Search Result, In Proceedings of the Second ACM International Conference on Web Search and Data Mining, ACM, 2009). Most methods use greedy procedures to sequentially select collections one at a time and optimize weighted combination of relevance and diversity scores. Analogous approach can also be employed here.

### Collection Quality

Collection quality is a query independent score that aims to measure the quality of documents in the collection as well as comprehensiveness and completeness of the collection as a whole. A number of factors should influence this score including:
size: number of documents in collection. More documents would typically mean that user put a lot of effort into this collection, indicating higher quality.
tags: number of tags in collection. Same rationale as size.
document freshness: average last update date for documents in collection. Information tends to change very quickly so stale collections containing documents that haven't been updated in a while will typically be of lower overall quality.
collection freshness: last update date for collection. Same rationale as document freshness.
uniqueness: average inverse popularity score across all collections (for example idf http://en.wikipedia.org/wiki/Tf-idf) for documents in collection. Collections containing less popular documents can be more interesting but can also be less relevant so there is a trade-off in using this component.
creator # collections: number of collections that this creator has created. More collections would indicate higher quality. Once usage data is available this can be extended to take into account whether users are interested in other collections from creator.
creator collection quality: average collection quality from creator.
creator social: is creator logged in through Facebook, Twitter etc.+social signals like number of followers, activity etc.
collection social: number of users that re-collected/saved this collection

Together, these and possibly other components will make up the collection quality score. Before combining all components into one score it is useful to standardize each component to have the same range (usually [0,1] or [−1, 1]. Typically, sigmoid or tan h functions are used for this purpose. Sigmoid is defined as:

$$σ ( x ) = \frac{1}{1 + exp ( - x )}$$

as x increases/decreases σ approaches 1/0. In this base form, σ reaches extremes very quickly, for example σ(5)≈0.99. To make this function applicable to larger x domains, a generalized version is often used:

$$σ ( x ) = \frac{1}{1 + exp ( - \frac{x - α}{β} )} \qquad ( 6 )$$

where ∝ shifts the function along the x-axis and β controls the speed of increase. In many instances ∝ can be set to mean/median of x and β to standard deviation.

After passing each component through the generalized sigmoid, we use weighted combination to derive the collection quality score:

$$S ( C ) = {\sum }_{i} \frac{{γ}_{i}}{1 + exp ( - \frac{{x}_{i} - {α}_{i}}{{β}_{i}} )} \qquad ( 7 )$$

where S(c) is the quality score for collection c, xᵢ is the i'th component (“size”, “tags” etc.), ∝ᵢ and βᵢ are sigmoid parameters for i'th component. γᵢ is the weight given to the i'th component and controls the contribution from each component to the overall score.

Once enough usage data is collected, these and other measure of collection quality can be used as feature input to a machine learning ranking model. The model would then be trained to automatically optimize feature weights and automatically estimate collection relevance and quality scores for each query.

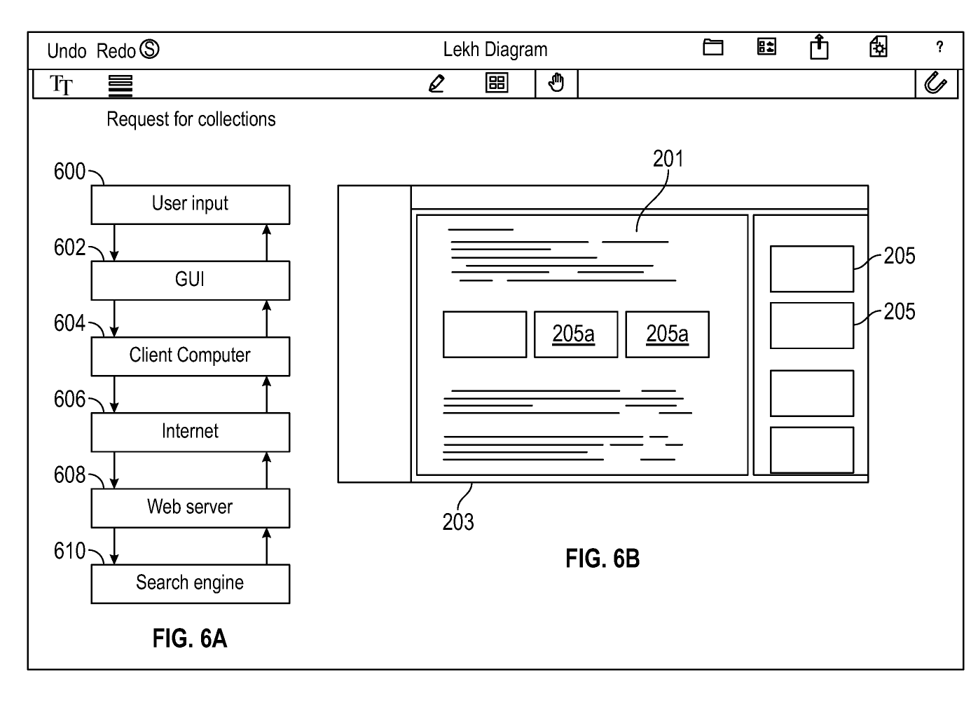

Thus, it can be seen, from FIGS. 6A and 6B of the drawings, and in summary, that a search engine in accordance with an exemplary embodiment of the present invention requires a user input 600, initially in the form of a search query, to a GUI 602 running on a user's computer 604. The user's computer is connected, via the Internet 606, to a web server 608, including the database on which the above-mentioned collections (i.e. the folders and the associated search results associated therewith) are stored, together with data representative of their creator and the order in which that creator has selected for their display; and the search engine 610 is communicably coupled to the web server 608.

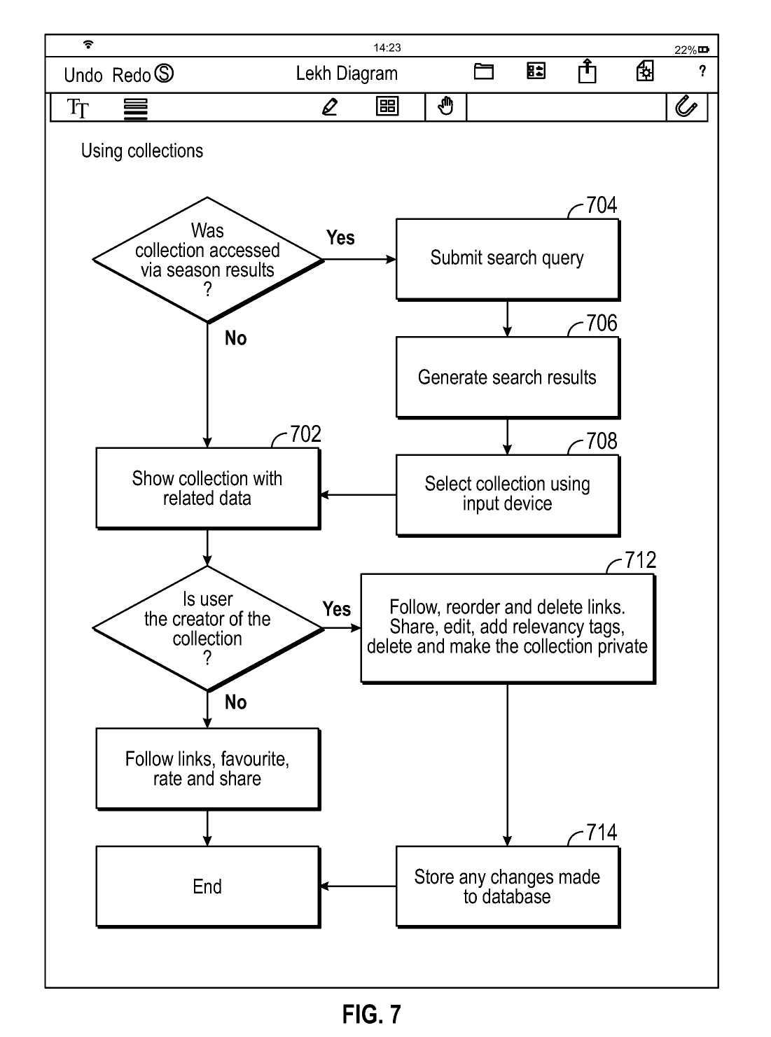

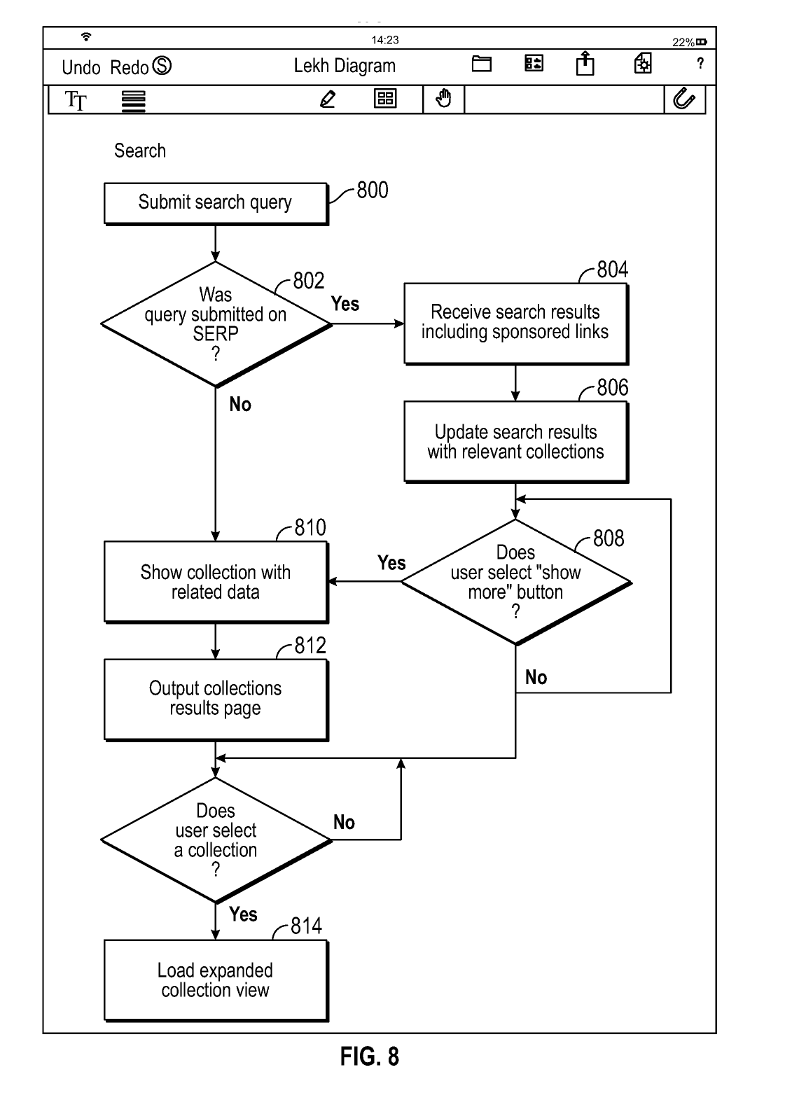

The following is a summary of the principal features of a search engine and GUI in accordance with an exemplary embodiment of the present invention, and reference is made to FIG. 7 and FIG. 8 of the drawings.

Thus, referring first to FIG. 7 of the drawings, a flow chart illustrating principal method steps of using collections (after their creation) in accordance with an exemplary embodiment of the present invention is illustrated. At the start of the process, the algorithm needs to know if the collection was accessed via search results (or via a user's own home page). Thus, a user can simply select one of their own collections (displayed on the right hand side of their screen, as previously described, and the algorithm is configured to simply open the folder and display its contents at step 702. Alternatively, a non-private collection may be accessed by its creator, or another user, via a search. Thus, as explained above, a search query is submitted, at step 704, search results including one or more collections are generated at step 706, and the user can then select one of the displayed collections using their input device at step 708, thus causing the folder to be opened and its contents displayed (step 702). The permissions associated with a collection differ, depending on whether or not the user is the creator of the collection and the level of privacy the creator has chosen for that collection. Thus, if the user is not the creator of a selected collection, they can follow links, bookmark the collection as a favourite, rate the collection and/or share it (at step 710), but they cannot change the contents of the collection in any way. However, if the user is the creator of the collection, they can reorder and delete links, share, edit and add relevancy tags, make the collection private and even delete the collection if they wish (step 712), and any changes made by the creator are automatically saved to the data base, at step 714, once made. A user can, in some exemplary embodiments of the invention, invite one or more other users to collaborate in creating a collection. Thus, a user can send a request to another user, for example, by entering their email address or user name and sending them an invitation. Once the invitation is accepted, that user will also have the ability to edit and add to the collection. It is envisaged that such editing privileges may be a restricted subset of those afforded to the original creator of the collection, as required by the creator.

FIG. 8 of the drawings illustrates schematically an algorithm representative of the search process within a search engine according to an exemplary embodiment of the present invention. The user submits a search query at step 300. The algorithm determines first, at step 802, whether or not the search query was submitted on the search engine results page (i.e. in the form of a standard search query) or in respect of collections only. If the search was performed in respect of collections only, the process jumps straight to step 810, and the collections found are displayed, including data representative of the links stored in the respective collection folders as a respective collections results page (812).

If the search query was entered via the search engine results page (SERP), an internet search is performed, as explained previously, and the search results, including sponsored links, are displayed in a list ordered by relevance at step 804. The search engine also searches non-private collections stored on the database, as described above, and updates the search results with relevant collections, at step 806, although these are only displayed at this stage as ‘tiles’ representative of the collections. In respect of the search results thus displayed, the user is given the option to select a ‘show more’ function (808), which relates to the collections with which the search results have been updated. If the user presses yes, the collections within the search results are displayed, including data representative of the links stored in the respective collection folders, at step 810 and the collections results page is output (812). A user can now select one of the displayed collections and, in response to such selection, the collection view is expanded to replace the current search results page, at step 814.

It will be appreciated by a person skilled in the art, from the foregoing description that modifications and variations can be made to the described embodiment without departing from the scope of the invention as defined by the appended claims.

1. A computer-implemented search system comprising a graphical user interface, an application programming interface communicably coupled to a search engine, and a database, said search engine being configured to perform an Internet search in response to a search query and display results of said search on a screen of a user's computing device, said application programming interface being configured to:
provide a selectable function and display a control element representative thereof, via said graphical user interface on said screen of said user's computing device, said selectable function being configured such that, when selected by a user, a new folder is created;
enable a user to select one or more search results displayed on said screen and cause it/them to be moved into said new folder;
display, via said graphical user interface, data representative of said new folder including said one or more search results contained therein; and
save said new folder including said one or more search results in said database;
said application programming interface being further configured to cause said search engine to perform a search of said database, in response to a search query, and display on said screen data representative of relevant folders including search results created by other users and stored in said database together with said search results.

2. A system according to claim 1, wherein said application programming interface is configured to enable a user to apply a chosen name to said folder, said name being in the form of an alphanumeric string entered by said user.

3. A system according to claim 1, wherein said application programming interface is configured to enable a user to select one or more search results displayed on said screen in respect of a further Internet search, and cause it/them to be moved to a folder created by said user.

4. A system according to claim 1, wherein said application programming interface is configured to enable a user to edit search results within a folder by deletion, amendment and/or reordering.

5. A system according to claim 1, wherein said application programming interface is configured to enable a user to attach a privacy tag to a folder, said privacy tag being configured to prevent a folder to which it is attached from being accessed by other users.

6. A system according to claim 1, wherein said application programming interface is configured to enable a user to attach one or more relevancy tags to a folder.

7. A system according to claim 1, wherein said application programming interface is configured to protect folders such that only user that created a folder can perform the one or more of the following actions in respect thereof: deletion of entries, sharing of said folder, reordering of contents, adding relevancy tags.

8. A system according to claim 1, wherein said application programming interface is configured to apply a score to a folder containing search results, said score being indicative of the potential relevance and/or quality of said search results.

9. A system according to claim 8, wherein said score is based on the identity of a user that created the respective folder.

10. A system according to claim 8, wherein said score is based on said search results, and is calculated using bounce rates of links to said search results and/or time spent scrolling through said search results by other users.

11. A system according to claim 8, wherein said score is based on relevance to search query, wherein said score is calculated using keyword relevance criteria.

12. A system according to claim 1, wherein said application programming interface is configured to enable a first user to invite other users to contribute search results to a folder created by said first user.

13. A system according to claim 12, wherein said application programming interface is configured to enable a user to send an electronic invitation to another user which, once accepted, causes said application programming interface to apply editing permissions to an invited user in respect of a specified folder.

14. A system according to claim 12, wherein said editing permissions are limited to the addition of search results to said specified folder.
